(19) United States
(12) Patent Application Publication
(10) Pub. No.: US 2024/0334091 A1
(43) Pub. Date: Oct. 3, 2024

(54) SYSTEM AND METHOD FOR RECEPTION OF ASYNCHRONOUS ENERGY METER RADIO TRANSMISSIONS

(71) Applicant: Copper Labs, Inc., Boulder, CO (US)

(72) Inventors: Morgan Jones, Denver, CO (US); Jeffrey P Mathews, Hygiene, CO (US)

(73) Assignee: Copper Labs, Inc., Boulder, CO (US)

(21) Appl. No.: 18/623,905

(22) Filed: Apr. 1, 2024

Related U.S. Application Data
(60) Provisional application No. 63/455,955, filed on Mar. 30, 2023.
(60) Provisional application No. 63/455,957, filed on Mar. 30, 2023.

(51) Int. Cl. H04Q 9/00

(52) U.S. Cl. CPC H04Q 9/00; H04Q 2209/60

(57) ABSTRACT

A system for reception of radio transmissions includes: a collector, coupled to a plurality of transmitters via a plurality of wireless radio frequency (RF) links. The collector has a channelizer chain that receives an RF signal stream comprising broadcasts from the plurality of transmitters according to one or more known packet transmission protocols, converts the RF signal stream into digital bit streams that each correspond to a corresponding frequency channel. The collector also has a plurality of packet receivers that comport with a number of frequency channels provided by the channelizer chain and that are coupled in parallel to the channelizer chain. Each of the receivers processes more than one sample within each bit of a corresponding digital bit stream to detect, demodulate, and decode bits of the corresponding digital bit stream into packet payloads. The collector validates the packet payloads and forwards the packet payloads to one or more entities.

### RELATED APPLICATIONS

This application claims the benefit of the following U.S. Provisional Applications, each of which is herein incorporated by reference in its entirety.

| SERIAL | FILING | |
|---|---|---|
| NUMBER | DATE | TITLE |
| 63/455,955 | Mar. 30, 2023 | SYSTEM AND METHOD FOR |
| (CL.0112P) | | RECEPTION OF ASYNCHRONOUS |
| | | ENERGY METER WIRELESS |
| | | RADIO TRANSMISSIONS |
| 63/455,957 | Mar. 30, 2023 | DIGITAL COMBINING OF OOK |
| (CL.0113P) | | MODULATED |
| | | SIGNALS FOR IMPROVED |
| | | SIGNAL STRENGTH |

This application is related to the following co-pending U.S. Patent Applications, each of which has a common assignee and common inventors, the entireties of which are herein incorporated by reference.

| SERIAL | FILING | |
|---|---|---|
| NUMBER | DATE | TITLE |
| (̅C̅L̅.̅0̅1̅1̅5̅)̅ | Apr. 1, 2024 | SYSTEM AND METHOD FOR SYNCLESS |
| | | RECEPTION OF ASYNCHRONOUS |
| | | ENERGY METER RADIO TRANSMISSIONS |
| (̅C̅L̅.̅0̅1̅1̅6̅)̅ | Apr. 1, 2024 | MULTIPLE ANTENNA SYSTEM AND |
| | | METHOD FOR RECEPTION OF |
| | | ASYNCHRONOUS RADIO SIGNALS |
| (̅C̅L̅.̅0̅1̅1̅7̅)̅ | Apr. 1, 2024 | SYSTEM AND METHOD FOR PRO- |
| | | GRAMMABLE RECEPTION OF |
| | | ASYNCHRONOUS RADIO SIGNALS |

### BACKGROUND OF THE INVENTION

### Field of the Invention

This invention relates in general to the field of radio frequency reception and processing, and more particularly to systems and methods for improved reception of energy meter consumption data from numerous and diverse metering transmissions.

### Description of the Related Art

The technologies associated with supply and consumption of energy resources such as electricity, water, and natural gas are constantly evolving as a result of pulls in the industry for increased supply and decreased cost. Though many energy suppliers (“utilities”) today still rely upon dedicated personnel to read consumer's utility meters every month, a substantial number of suppliers have installed advanced meter reading (AMR) meters according to Advanced Metering Infrastructure (AMI) specifications. These AMR (or “smart”) meters are configured to regularly and periodically broadcast their current consumption values so that a compatible meter reading receiver can obtain the consumption values and forward those values on to a corresponding utility. The utilities use these values to bill their consumers, among other uses.

Smart meters utilize wireless radio frequency (RF) transmitters to broadcast their readings according to several different protocols, among which is the well-known Encoder Receiver Transmitter (ERT) Packet Protocol. ERT is a frequency hopping protocol for low-level transmissions in the 900 MHz band with a baseband bit rate of 32,768 bits per second. In accordance with a specified hop sequence, all of the smart meters within a given area will transmit their reading packet (e.g., meter identification, time of day, current consumption value, etc.) at a given RF frequency and then hop to the next RF frequency in the sequence and transmit a next current reading packet. Protocols such as ERT make no provisions for packet collision avoidance and thus rely upon their hop sequence to allow for packets from individual meters to eventually be received by a meter reading collector.

Technologies for collecting meter readings fall into two categories: fixed collectors and mobile collectors. In the case of fixed collectors, a utility may deploy collector receivers in fixed locations that will provide for reception of packets from approximately 10-20 meters. The coverage area of these fixed collectors is intentionally limited because the transmissions from the individual smart meters are low power transmissions, and 2) present-day timeliness requirements from most utilities are on the order of minutes, which constrains the number of meters that a given receiver can address in order to limit packet error rate such that those timeliness requirements are met. Mobile collectors are generally transported by a slow-moving vehicle and move from facility to facility, often circling back to obtain readings from meters that were missed as a result of packet collisions.

The current technologies work and meter readings are obtained, eventually. Current capabilities notwithstanding, the present inventors have noted that timeliness requirements from utilities and energy analytics companies are becoming more stringent, moving from the order of minutes to the order of seconds. In addition, it has been noted that it is labor-intensive to maintain a large number of limited-area collectors or mobile collection infrastructures. Accordingly, the present inventors have realized a pull in the art for fixed-location collectors that are capable of collecting consumption data from a large number of meters, almost two orders of magnitude greater than that which has heretofore been provided. Yet, as one skilled in the art will appreciate, to deploy such a fixed-location collector requires that it be placed in a location so that the transmissions from these meters (700 to 1000) can be received. Consequently, power levels of the transmissions from the meters are substantially attenuated and the number of packet collisions is exponentially increased, thus precluding the use of present-day collectors in such a deployment.

Accordingly, what is needed is a system and method for improved reception of large number of energy meter radio transmission.

What is also needed is are techniques for timely reception, detection, demodulation, and decoding of energy meter packet transmissions that exhibits lower packet error rates than that which has heretofore been provided.

What is further needed are mechanisms and methods for improved reception of transmitted low power RF transmissions and capture of data that is encoded within those transmissions.

What is moreover needed is a system and method for employing multiple antennas to capture and decode transmissions from a substantial number of RF transmitters.

What is additionally needed is are techniques for tailoring a neighborhood-level energy meter collection system to receive selective metering transmission protocols.

### SUMMARY OF THE INVENTION

The present invention, among other applications, is directed to solving the above-noted problems and addresses other problems, disadvantages, and limitations of the prior art by providing a superior technique for receiving and decoding large numbers of low-power transmitted message that are broadcast according to a known packet protocol.

In one embodiment, a system for reception of radio transmissions is provided, the system including: a collector, coupled to a plurality of transmitters via a plurality of wireless radio frequency (RF) links, where: each of the plurality of transmitters broadcasts corresponding encoded packets over a corresponding wireless RF link; the broadcasts comport with one or more packet transmission protocols that are known by the collector; and the collector is configured to detect, demodulate, and decode the broadcasts from the each of the plurality of transmitters to extract corresponding packet payloads; the collector including: a channelizer chain, configured to: receive an RF signal stream including one or more broadcasts via an antenna tuned to a spectrum corresponding to the one or more packet transmission protocols; downconvert the RF signal stream to an analog signal stream at a baseband of the one or more packet transmission protocols; convert the analog signal stream into a digital bitstream; and transform the digital bitstream into a plurality of channelized bit streams that comport with a number of frequency channels within the one or more packet transmission protocols; and packet receivers, coupled to the channelizer chain in parallel relative to each other, each configured to: receive a corresponding one of the plurality of channelized bit streams; upon detection of a bit edge transition within the corresponding one of the plurality of channelized bit streams, process in parallel, a plurality of samples within each bit of the corresponding one of the plurality of channelized bit streams to detect a synchronization sequence, demodulate raw bits and transform the raw bits into packet bytes and checksum bytes, transform the packet bytes into a packet payload, compute a checksum of the packet bytes for comparison to the checksum bytes, and if the computed checksum is equal to the checksum bytes, provide the packet payload for validation; validate corresponding packet payloads derived in parallel from more than one of the plurality of samples by selecting an optimum one of the corresponding packet payloads; and provide the optimum one of the corresponding packet payloads to an upper layers processor for formatting and transmission to one or more entities.

One aspect of the present invention contemplates a system for reception of radio transmissions, the system including: a collector, coupled to a plurality of Advanced Meter Reading (AMR) meters via a plurality of wireless radio frequency (RF) links, where: each of the plurality of AMR meters broadcasts corresponding encoded packets over a corresponding wireless RF link; the broadcasts comport with one or more Encoder Receiver Transmitter (ERT) packet transmission protocols that are known by the collector; and the collector is configured to detect, demodulate, and decode the broadcasts from the each of the plurality of AMR meters to extract corresponding ERT packet payloads; the collector including: a channelizer chain, configured to: receive an RF signal stream including one or more broadcasts via an antenna tuned to a spectrum corresponding to the one or more ERT packet transmission protocols; downconvert the RF signal stream to an analog signal stream at a baseband of the one or more ERT packet transmission protocols; convert the analog signal stream into a digital bitstream; and transform the digital bitstream into a plurality of channelized bit streams that comport with a number of frequency channels within the one or more ERT packet transmission protocols; and packet receivers, coupled to the channelizer chain in parallel relative to each other, each configured to: receive a corresponding one of the plurality of channelized bit streams; upon detection of a bit edge transition within the corresponding one of the plurality of channelized bit streams, process in parallel, a plurality of samples within each bit of the corresponding one of the plurality of channelized bit streams to detect a synchronization sequence, demodulate raw bits and transform the raw bits into packet bytes and checksum bytes, transform the packet bytes into an ERT packet payload, compute a checksum of the packet bytes for comparison to the checksum bytes, and if the computed checksum is equal to the checksum bytes, provide the ERT packet payload for validation; validate corresponding ERT packet payloads derived in parallel from more than one of the plurality of samples by selecting an optimum one of the corresponding ERT packet payloads; and provide the optimum one of the corresponding ERT packet payloads to an upper layers processor for formatting and transmission to one or more energy services.

Another aspect of the present invention envisages a method for reception of radio transmissions, the method including: coupling a collector to a plurality of transmitters via a plurality of wireless radio frequency (RF) links, where: each of the plurality of transmitters broadcasts corresponding encoded packets over a corresponding wireless RF link; the broadcasts comport with one or more packet transmission protocols that are known by the collector; and the collector is configured to detect, demodulate, and decode the broadcasts from the each of the plurality of transmitters to extract corresponding packet payloads; via a channelizer chain disposed within the collector: receiving an RF signal stream including one or more broadcasts via an antenna tuned to a spectrum corresponding to the one or more packet transmission protocols; downconverting the RF signal stream to an analog signal stream at a baseband of the one or more packet transmission protocols; converting the analog signal stream into a digital bitstream; and transforming the digital bitstream into a plurality of channelized bit streams that comport with a number of frequency channels within the one or more packet transmission protocols; and via each of a plurality of packet receivers disposed within the collector and coupled to the channelizer chain in parallel relative to each other: receiving a corresponding one of the plurality of channelized bit streams; upon detection of a bit edge transition within the corresponding one of the plurality of channelized bit streams, processing in parallel, a plurality of samples within each bit of the corresponding one of the plurality of channelized bit streams to detect a synchronization sequence, demodulate raw bits and transform the raw bits into packet bytes and checksum bytes, transform the packet bytes into a packet payload, compute a checksum of the packet bytes for comparison to the checksum bytes, and if the computed checksum is equal to the checksum bytes, provide the packet payload for validation; validating corresponding packet payloads derived in parallel from more than one of the plurality of samples by selecting an optimum one of the corresponding packet payloads; and providing the optimum one of the corresponding packet payloads to an upper layers processor for formatting and transmission to one or more entities.

### BRIEF DESCRIPTION OF THE DRAWINGS

These and other objects, features, and advantages of the present invention will become better understood with regard to the following description, and accompanying drawings where:

FIG. 1 is a block diagram illustrating a neighborhood-level energy meter data collection system according to the present invention;

FIG. 2 is a flow diagram depicting a present-day method for reception and processing of energy meter radio transmissions to recover packets according to a specified protocol;

FIG. 3 is a flow diagram featuring a method according to the present invention for improved reception and processing of energy meter radio transmissions to recover packets according to a specified protocol that employs sample diversification to increase packet rate;

FIG. 4 is a flow diagram showing a method according to the present invention for improved reception of energy meter radio transmissions to recover packets according to a specified protocol that employs sample-diversified syncless processing to further increase packet rate over the method of FIG. 3;

FIG. 5 is a block diagram illustrating a 4-sample diversified syncless packet reception mechanism according to the present invention;

FIG. 6 is a block diagram detailing a sample-diversified ERT packet channelizer/receiver according to the present invention;

FIG. 7 is a block diagram showing a multiple-antenna embodiment of a sample-diversified ERT packet channelizer/receiver according to the present invention;

FIG. 8 is a block diagram illustrating a sample-diversified packet receiver according to the present invention; and

FIG. 9 is a block diagram depicting a programmable neighborhood-level meter data collector according to the present invention.

### DETAILED DESCRIPTION

Exemplary and illustrative embodiments of the invention are described below. It should be understood at the outset that although exemplary embodiments are illustrated in the figures and described below, the principles of the present disclosure may be implemented using any number of techniques, whether currently known or not. In the interest of clarity, not all features of an actual implementation are described in this specification, for those skilled in the art will appreciate that in the development of any such actual embodiment, numerous implementation specific decisions are made to achieve specific goals, such as compliance with system-related and business-related constraints, which vary from one implementation to another. Furthermore, it will be appreciated that such a development effort might be complex and time-consuming, but would nevertheless be a routine undertaking for those of ordinary skill in the art having the benefit of this disclosure. Various modifications to the preferred embodiment will be apparent to those skilled in the art, and the general principles defined herein may be applied to other embodiments. Therefore, the present invention is not intended to be limited to the particular embodiments shown and described herein, but is to be accorded the widest scope consistent with the principles and novel features herein disclosed.

The present invention will now be described with reference to the attached figures. Various structures, systems, and devices are schematically depicted in the drawings for purposes of explanation only and so as to not obscure the present invention with details that are well known to those skilled in the art. Nevertheless, the attached drawings are included to describe and explain illustrative examples of the present invention. Unless otherwise specifically noted, articles depicted in the drawings are not necessarily drawn to scale.

The words and phrases used herein should be understood and interpreted to have a meaning consistent with the understanding of those words and phrases by those skilled in the relevant art. No special definition of a term or phrase (i.e., a definition that is different from the ordinary and customary meaning as understood by those skilled in the art) is intended to be implied by consistent usage of the term or phrase herein. To the extent that a term or phrase is intended to have a special meaning (i.e., a meaning other than that understood by skilled artisans) such a special definition will be expressly set forth in the specification in a definitional manner that directly and unequivocally provides the special definition for the term or phrase. As used in this disclosure, “each” refers to each member of a set, each member of a subset, each member of a group, each member of a portion, each member of a part, etc.

Applicants note that unless the words “means for” or “step for” are explicitly used in a particular claim, it is not intended that any of the appended claims or claim elements are recited in such a manner as to invoke 35 U.S.C. § 112 (f).

### Definitions

Integrated Circuit (IC): A set of electronic circuits fabricated on a small piece of semiconductor material, typically silicon. An IC is also referred to as a chip, a microchip, or a die.
Central Processing Unit (CPU): The electronic circuits (i.e., “hardware”) that execute the instructions of a computer program (also known as a “computer application,” “application,” “application program,” “app,” “computer program,” or “program”) by performing operations on data, where the operations may include arithmetic operations, logical operations, or input/output operations. A CPU may also be referred to as a “processor.”
Module: As used herein, the term “module” may refer to, be part of, or include an application specific integrated circuit (ASIC), an electronic circuit, a processor (shared, dedicated, or group) and/or memory (shared, dedicated, or group) that execute one or more computer programs, a combinational logic circuit, and/or other suitable components that provide the described functionality.
Microprocessor: An electronic device that functions as a CPU on a single integrated circuit. A microprocessor receives digital data as input, processes the data according to instructions fetched from a memory (either on-die or off-die), and generates results of operations prescribed by the instructions as output. A general-purpose microprocessor may be employed in a desktop, mobile, or tablet computer, and is employed for uses such as computation, text editing, multimedia display, and Internet browsing. A microprocessor may also be disposed in an embedded system to control a wide variety of devices including appliances, mobile telephones, smart phones, and industrial control devices.
Multi-Core Processor: Also known as a multi-core microprocessor, a multi-core processor is a microprocessor having multiple CPUs (“cores”) fabricated on a single integrated circuit.
Microcode: A term employed to refer to a plurality of micro instructions. A micro instruction (also referred to as a “native instruction”) is an instruction at the level that a microprocessor sub-unit executes. Exemplary sub-units include integer units, floating point units, MMX units, and load/store units. For example, micro instructions are directly executed by a reduced instruction set computer (RISC) microprocessor. For a complex instruction set computer (CISC) microprocessor such as an x86-compatible microprocessor, x86 instructions are translated into associated micro instructions, and the associated micro instructions are directly executed by a sub-unit or sub-units within the CISC microprocessor.
Internet: The Internet is a global wide area network connecting computers throughout the world via a plurality of high-bandwidth data links which are collectively known as the Internet backbone. The Internet backbone may be coupled to Internet hubs that route data to other locations, such as web servers and Internet Service Providers (ISPs). The ISPs route data between individual computers and the Internet and may employ a variety of links to couple to the individual computers including, but not limited to, cable, DSL, fiber, and Wi-Fi to enable the individual computers to transmit and receive data over in the form of email, web page services, social media, etc. The Internet may also be referred to as the world-wide web or merely the web.

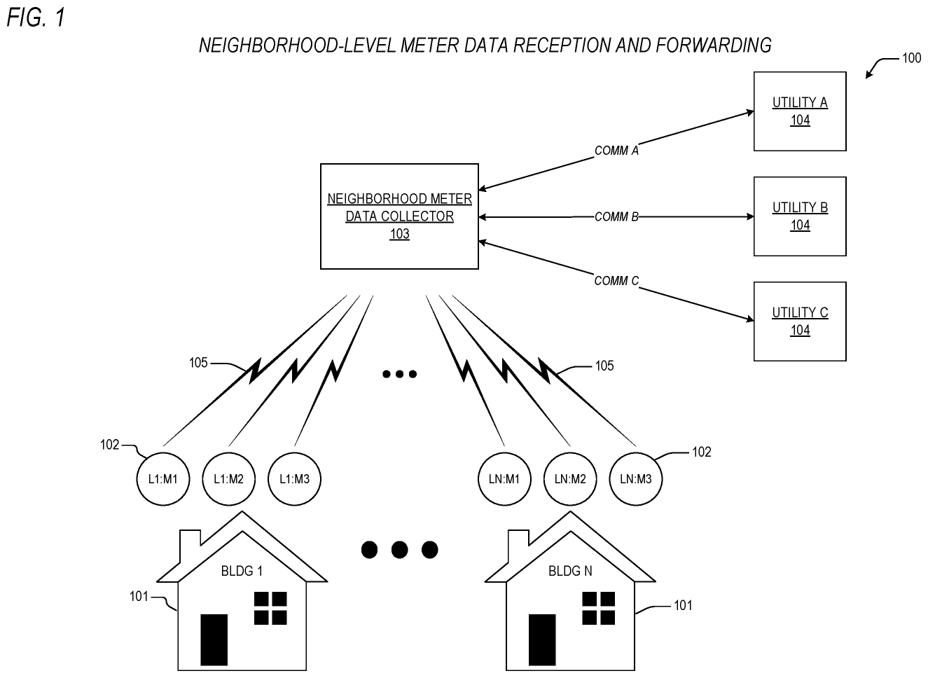

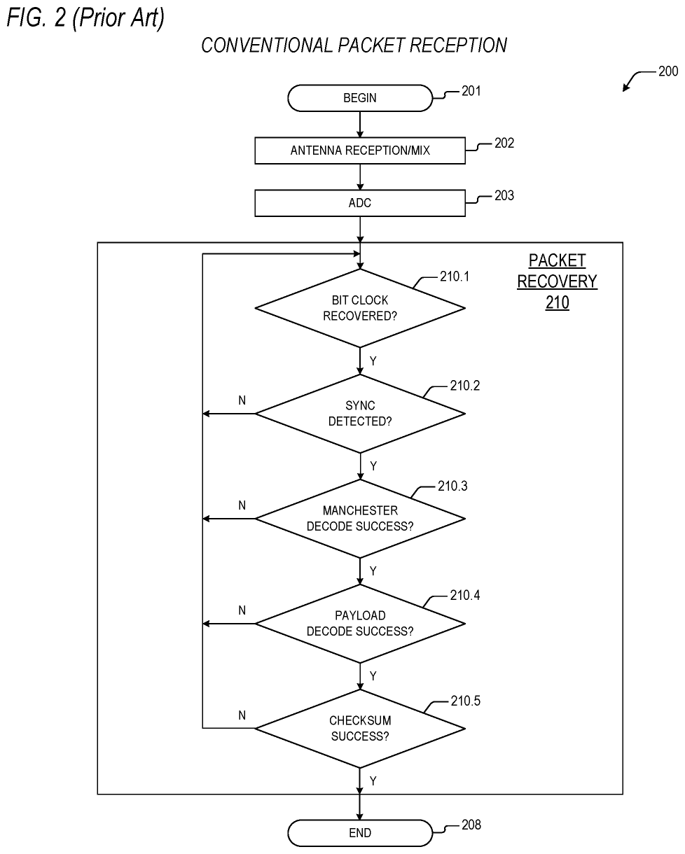

In view of the above background discussion on energy meter consumption transmissions and reception and associated techniques employed within present-day receivers for reception of corresponding radio signals and extraction of packets according to specified protocols, a discussion of the present invention will now be presented with reference to FIGS. 1 and 3-9 along with a discussion of those present-day associated techniques with reference to FIG. 2.

Turning to FIG. 1, a block diagram is presented illustrating a neighborhood-level energy meter data collection system 100 according to the present invention. The system 100 includes a neighborhood meter data collector 103 that is coupled to one or more energy services 104 via one or more communication links COMM A, COMM B, COMM C. In one embodiment, the data collector 103 is mounted on a pedestal (not shown) at a height above a plurality of energy consuming facilities 101 denoted in the diagram as BLDG 1 101 through BLDG N 101. Each facility 101 may consume one or more types of metered energy such as, but not limited to, electricity, water, natural gas, coal, wood, and the like. Each facility 101 may have a so-called “automatic meter reading (AMR) meter” (“smart meter”) 102 that corresponds to each type of metered energy that the facility 101 consumes. For example, BLDG 1 101 has three smart meters 102: L1: M1, L1: M2, and L1: M3 that each measure consumption of a particular type of energy and that periodically broadcast consumption of that particular type of energy via radio frequency (RF) signal transmissions over a corresponding radio frequency (RF) link 105 according to a specified RF protocol so that the data collector 103 may detect, demodulate, and decode the RF signal transmissions to extract one or more packets that comprise identification of the particular smart meter 102 associated with a particular set of the RF signal transmissions along with time of day and corresponding consumption readings for the particular smart meter.

For purposes of clearly teaching the present invention, it is presumed that the energy services 104 are conventional utility providers such as those which provide the facilities 101 with electricity, water, and natural gas and the individual meters 102 associated with a given facility 101 are configured to measure consumption of electricity, water, and gas, respectively, for the given facility and to periodically broadcast consumption of those energy sources via corresponding RF signal transmissions over corresponding RF links 105. In addition, the data collector 103 is configured to detect, demodulate, and decode the RF signal transmissions to extract one or more packets that comprise identification of the particular smart meter 102 associated with a particular set of the RF signal transmissions along with time of day and corresponding consumption readings for the particular smart meter and to forward those consumption readings on to their respective energy services 104. Though the energy services 104 are associated with convention utility companies, the present inventors note that the services 104 may comprise other entities that need energy consumption data of one or more types for purposes of analyzing and forecasting energy usage of a facility 101 or of a group of facilities 101 within a geographic area that is covered by the data collector 103.

In one embodiment, the height of the pedestal may be determined to enable relatively clear RF line of sight for RF energy meter transmissions associated with a specified number of facilities 101. For example, the height of the pedestal may enable reception of RF meter transmission for over 500 energy consumption meters 102. Another embodiment contemplates mounting of the data collector 103 on conventional utility transmission poles at least 40 inches below power lines and between 8 and 27 feet above grade, which is commonly known as the low-voltage equipment area.

In operation, the data collector 103 scans the frequency bands associated with the RF transmissions from the energy consumption meters 102 over the various RF links 105 to detect, demodulate, and decode each of the RF transmissions and to extract corresponding energy consumption data (e.g., meter identification, time of day, consumption, etc.) and transmit that data to a corresponding energy service 104.

Each of the communication channels COMM A, COMM B, COMM C may comprise one or more of these well-known communication mediums including, but not limited to, cable, digital subscriber line (DSL), optical fiber, RF links, satellite links, the internet, and Wi-Fi. Each of the RF links 105 may employ RF communications associate with any of the well-known energy consumption transmission protocols for so-called automatic meter reading (AMR) energy consumption meters such as, but not limited to, variations of Encoder Receiver Transmitter (ERT) Packet Protocol, which is a is a 900 MHz wireless technology developed to transmit meter data from electric, gas, and water meters over a short range. These variations include ERT-SCM, ERT-SCMP, and ERT-IDM. ERT is described in U.S. Pat. No. 4,614,945 to Brunius et al., U.S. Pat. No. 4,799,059 to Grindahl et al., and U.S. Pat. No. 7,830,874 to Cornwall et al., each of which is herein incorporated by reference in its entirety.

As one skilled in the art will appreciate, ERT is an on-off keying (OOK) modulated radio signal which is transmitted in the unlicensed 900-920 MHz band. The ERT protocol uses Manchester encoding for packets and employs frequency-hopping to avoid interference with other nearby meters. It is not a purpose of the present application to teach ERT or any other energy consumption metering protocol because these protocols are well-known in the industry. Rather, the focus of the present application is to address limitations of the prior art that have been noted by the present inventors when large numbers of RF energy meter transmissions are received by receivers such as the data collector 103 of FIG. 1.

One skilled in the art will appreciate that when a wireless data collector 103 is configured to cover more area by increasing sensitivity of its internal RF receivers, the receivers within become more susceptible to packet loss due to noise, multipath fading, and in-band frequency interference as a result.

Consider the well-known Advanced Metering Infrastructure (AMI) residential and commercial energy consumption meters that utilize AMR meters 102 to transmit their readings according to a variety of well-known frequency hopping protocols, predominantly variations of ERT. Their transmissions are not coordinated nor are they synchronous. Thus, to deploy a collector 103 for reception of their transmissions at the level of a neighborhood would require collection of energy data from a large number of transmitters (e.g., over 500 transmitters) over a wide coverage area. Because the transmitters are uncoordinated and asynchronous, a significant number of packet collisions result.

There are three homes per acre in the average subdivision according to The National Association of Home Builders Economics and Housing Policy. As one skilled in the art will appreciate, when reception range of a receiver is doubled, the number of transmitting interferers quadruples. Assuming the neighborhood is laid out in a grid fashion, the relationship between radio receiver radius, number of homes, and the number of interfering energy consumption (e.g., gas, water, and electric) meters are shown in the following table:

| | | | | | | Meters |
|---|---|---|---|---|---|---|
| Radio Radius | | Lot Size | | Acres | Homes | (Transmitters) |
| 100 | ft | 200 × 200 | ft | 1 | 3 | 9 |
| 200 | ft | 400 × 400 | ft | 3.6 | 10 | 30 |
| 400 | ft | 800 × 800 | ft | 14.7 | 44 | 132 |
| 1600 | ft | 3200 × 3200 | ft | 235 | 705 | 2115 |
| 3200 | ft | 6400 × 6400 | ft | 940 | 2820 | 8460 |

Energy consumption meters are considered installed assets and thus cannot be replaced or updated with improved communications techniques to better alleviate active and passive causes of interference. Consequently, the present inventors have noted that present-day collection systems would suffer from extremely low levels of packet throughput when deployed at the neighborhood level. The present inventors have also noted that the only way to decrease packet collisions is to deploy more, less-sensitive collector receivers or to employ less-sensitive mobile receivers, both undesirable alternatives. Accordingly, it is an object of the present invention to overcome the above-noted and other limitations of the art by providing a fixed-location data collector 103 having high sensitivity relative to today's collectors, but that is capable of detecting, demodulating, and decoding large numbers of energy meter RF transmissions with increased packet throughput in the presence of both active and passive interference.

Before discussing how the present invention overcomes these limitations of the prior art, a discussion of present-day packet reception techniques will be presented below with reference to FIG. 2 to teach how conventional receivers are significantly constrained when exposed to a significant number of transmitters.

FIG. 2 is a flow diagram 200 depicting a present-day method for reception and processing of energy meter radio transmissions to recover packets according to a specified protocol, such as the ERT protocol discussed above.

Flow begins at block 201 where one or more energy meter RF signal transmissions are present at the conventional receiver. Flow then proceeds to block 202.

At block 202, the one or more energy meter RF signals are received by an antenna and are passed through a mixer element to translate from a carrier frequency to a baseband frequency. As one skilled in the art will appreciate, the ERT protocol has a maximum number of 60 RF channels that begin at 902.6 MHz and which are each 200 KHz wide in sequential ascending order. Variants of ERT may employ all of the 200 KHz channels or a subset of the channels according to a prescribed frequency hopping sequence that corresponds to the variant of ERT that is employed, that is, the number of and specified channels employed within a given ERT variant varies by implementation. One skilled will also appreciate that the baseband frequency for ERT is 32.768 Kb/sec. Thus, the mixer element downconverts the received signals in the 900 MHz spectrum described above to a frequency sufficient for sampling a 32.768 kHz waveform, generally 2-4 times baseband frequency. Flow then proceeds to block 203.

At block 203, the baseband RF stream is passed through an analog-to-digital converter, thus generating a bit stream at 2-4 times the baseband frequency. Flow then proceeds to block 210 for reception of packets from the downconverted bit stream.

At decision subblock 210.1, since the bit rate of the stream is known, edge detection is employed to enable reception of a bit clock within the stream. If an edge is detected, then flow proceeds to decision subblock 210.2. If an edge is not detected, flow proceed back to decision subblock 210.1 where the stream continues to be sampled for an edge.

At decision subblock 210.2, the edge-detected bit stream is then sampled to detect a synchronization sequence, which is employed to recover the bit clock and to establish DC balance and which demarcates the beginning of a packet payload. Upon reception of the bit clock, the bit stream is then sampled at the optimum time within each bit to determine if the bit is a logical 1 or a logical 0. The optimum time is typically mid-bit, that is, half a bit time after the edge. If the preamble sequence is not detected, then flow proceeds to decision subblock 210.1 where the stream continues to be sampled for an edge. If the sync sequence is detected, then the bit clock is established, and DC bias is set in the receiver. Flow then proceeds to decision subblock 210.3.

At decision subblock 210.3, the bit stream, which is Manchester-encoded, is decoded to produce bits in the packet payload. If decoding is unsuccessful, then flow proceeds to decision subblock 210.1. If the packet payload is successfully decoded, then flow proceeds to decision subblock 210.4.

At decision subblock 210.4, the decoded packet payload bits are evaluated against the packet format according to the specific protocol associated with the bit stream to determine the data values within each field of the s payload. If decode of the packet payload is successful (i.e., valid data values), then flow proceeds to decision subblock 210.5. If decode of the packet payload is unsuccessful, then flow proceeds to decision subblock 210.1.

At decision subblock 210.5, the decoded payload packet is evaluated to determine if a calculated CRC checksum of the data bits matches a CRC checksum word that is transmitted at the end of the packet payload. If the calculated CRC checksum matches the CRC checksum word, then flow proceeds to block 208. If the checksums do not match, then flow proceeds to decision subblock 210.1.

At block 208, flow completes with successful reception of a packet.

It is noted the for reception of ERT signals, the flow diagram 200 depicts reception of signals within a single 200 kHz channel as conventional receivers listen to each channel and then follow a hop sequence.

The example of FIG. 2 is provided to highlight the potential for any number of errors, such as those exhibited by decision subblocks 210.1-210.5 during packet reception 210, to result in failure to recover (e.g., properly receive, demodulate, and decode) transmitted packets in an environment where packets from numerous transmitters are transmitted asynchronously without protocol provisions to preclude collisions and errors. When one of the steps 210.1-210.5 fails, the receiver has to start over again. This is precisely the reasons that present-day ERT receivers exhibit acceptable packet throughput rates only when processing a small number of ERT transmissions. Since packets are periodically transmitted over different frequency channels, these low-sensitivity receivers will eventually successfully decode the RF transmissions from the limited number of collocated energy meters within their range. Mobile receivers may have to make multiple passes or, in a fixed collector case, overlap of adjacent meters is enabled via spacing of the collectors to provide redundant reception resources.

The present inventors have observed a need within the art for more time-granular consumption data from meters to support both provider and consumer demands such as, but not limited to, demand pricing, demand response, and time-of-day consumption activity detection and regulation. In addition, cost of infrastructure considerations is driving the field toward the use of neighborhood level collectors, such as will be described in further detail below. Yet, deployment of collectors at such a level will result in exponentially more collisions of signals that are markedly reduced in power over those which are processed by present-day collectors. Accordingly, a neighborhood-level collector must have a relatively high sensitivity, but also must exhibit a packet throughput rate that will satisfy the requirements for fine-grained consumption data, namely, on the order of seconds as opposed to days.

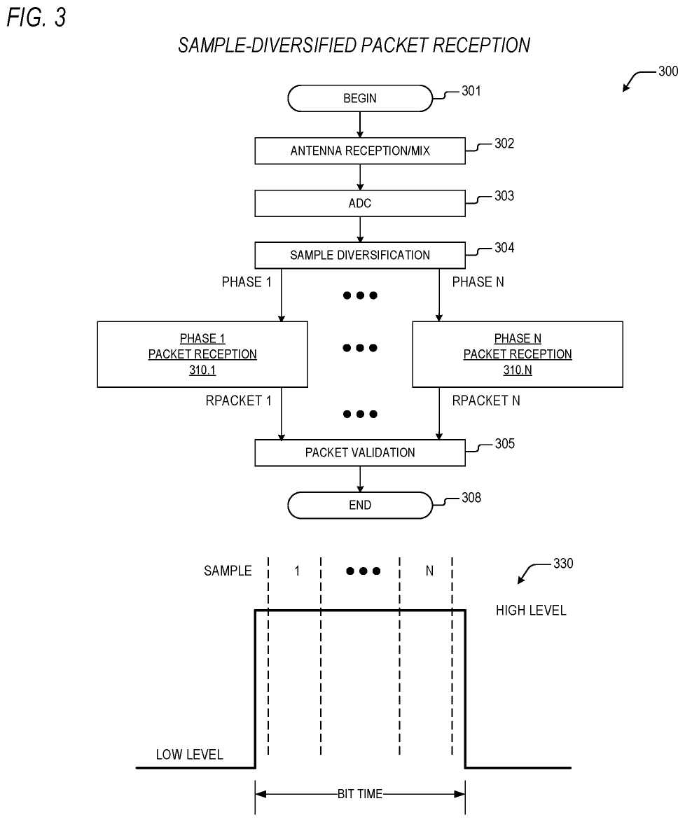

The present invention overcomes these limitations by providing a packet processing technique that allows for increase packet throughput of a large number of low-level signals according to known protocols that transmit periodically. The present invention will now continue to be described with reference to FIGS. 3-9.

Now referring to FIG. 3, a flow diagram 300 is presented featuring a method according to the present invention for improved reception and processing of energy meter radio transmissions to recover packets according to a specified protocol that employs sample diversification to increase packet rate. The present inventors note that it is a feature of the present invention to overcome the constraints and limitations experienced by convention receivers, such as the receiver exemplified in the flow diagram 200 of FIG. 2, by two primary techniques: 1) processing all frequency channels in parallel (i.e., simultaneously) according to the specific protocol employed and 2) employing sampling diversity within each of the simultaneously processed frequency channels. Both of these techniques significantly increase probability of packet reception for a neighborhood-level collector 103, thus exhibiting a substantial increase in packet throughput. The present inventors note that a collector 103 that utilizes only the sampling diversity technique according to the present invention shows a decrease in packet error rate of approximately 10-15 percent over conventional packet reception methods and processing all of the channels at the same time enables reception of packets in different channels at the same time. Though the following discussion of the present invention focuses on reception of ERT transmissions, such a discussion is provided to clearly teach the present invention because ERT is a well-known and ubiquitous protocol; however, the present inventors note that sampling diversity and parallel processing of frequency channels to increase packet throughput for known protocols may be applied to virtually any other modulated signal including, but not limited to on-off keying (OOK), frequency shift keying (FSK), orthogonal frequency division multiplexing (OFDM), and quadrature phase shift keying (QPSK).

Flow begins at block 301 where one or more energy meter RF signal transmissions are present at the collector receiver 103 according to the present invention. Flow then proceeds to block 302.

At block 302, the one or more energy meter RF signals are received by an antenna and are passed through a mixer element to translate from a carrier frequency to a baseband frequency. In an ERT protocol embodiment, the mixer element downconverts the received signals in the 900 MHz spectrum described above to a frequency sufficient for sampling a 32.768 kHz waveform, generally 2-4 times baseband frequency. Flow then proceeds to block 303.

At block 303, the baseband RF stream is passed through an analog-to-digital converter (ADC), thus generating a bit stream at 2-4 times the baseband frequency. Flow then proceeds to block 304.

The present inventors note that steps 304-308 are provided to illustrate sampling diversity for a single RF channel. In the collector 103 according to the present invention, steps 304-308 are performed in parallel for all frequency channels utilized by the specified protocol. In an ERT protocol embodiment, up to 60 200 kHz channels are simultaneously processes via steps 304-308.

At block 304, the phases 10-N within a bit time of the bit stream generated by the ADC step 303 to diversify phases withing each bit time. Waveform 330 shows phases within which samples will be evaluated in parallel by packet reception steps 310.1-310.N. More specifically, phase 1 reception step 310.1 will perform packet reception steps like those described above in step 210 of FIG. 2 only during the time shown in the waveform for SAMPLE 1. Likewise, phase 2 reception step 310.2 will perform packet reception steps only during the time shown in the waveform for SAMPLE 2. And phase N reception step 310.N will perform packet reception steps only during the time shown in the waveform for SAMPLE N. Properly received packets from each of the phases are provided to packet validation step 305 on busses RPACKET 1-RPACKET N.

At packet validation step 305, one or more successfully decoded packets (including checksum match) as validated. In one embodiment, if more than one packet is provided, then the provided packets are compared to determine if they are the same. If they are not the same, then they are all rejected. In another embodiment, the value of the majority of packets that are the same is employed as the packet value. In a further embodiment, the potential packets are statistically ranked from highest probability of being valid to lowest probability of being valid, and the packet validation step 305 choses the provided decoded packet that corresponds to the highest probability of being valid as the valid packet. If that packet is not provided, then the second highest provided packet is chosen as the valid packet. And so on. Flow then proceeds to block 308.

At block 308, the method completes.

In one embodiment, the number of bit time phases N is 4. Thus, a provided bit will be sampled at 4 equidistant times therein. Another embodiment contemplates 6 bit time phases. Further embodiments may select specific phases to sample. For example, in a 4-phase embodiment, the collector 103 may select to perform packet reception for samples 1 and 3 (e.g., 310.1 and 310.3, but not 310.2 or 310.4).

As one skilled in the art will appreciate, employment of sampling diversity within a single RF channel markedly increases the likelihood of packet reception, thus resulting is a lower bit error rate over than which has heretofore been provided.

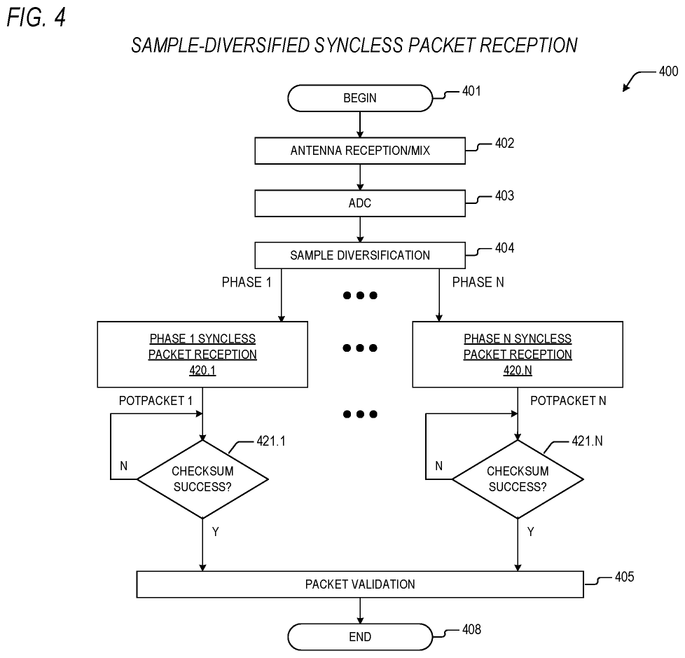

Turning now to FIG. 4, a flow diagram 400 is presented showing a method according to the present invention for improved reception of energy meter radio transmissions to recover packets according to a specified protocol that employs sample-diversified syncless processing to further increase packet rate over the method of FIG. 3.

In operation, flow of steps 401-405, 408 is the same as flow of like-numbered steps 301-305, 308 of FIG. 3, where the hundreds digit is replaced by a 4. The difference between the embodiment of FIG. 3 and the embodiment of FIG. 4 is that syncless packet reception elements 420.1-420.N do not require steps 210.2-210.4 of FIG. 2. Stated differently, once a bit clock and DC balance has been established, then every following bit is treated as though it were data. When enough bits to fill a packet of the specified protocol are received, the bits, assembled into parallel byte FIFOs, are treated as complete packets, where the last bytes are assumed to be a checksum value for the packet, and the potential packet, along with the potential checksum is passed to checksum success decision steps 421.1-421.N via busses POTPACKET 1-POTPACKET N. The checksum success decision steps 421.1-421.N perform a cyclic redundancy check (CRC) on the preceding bytes in all presumed packets. If the calculated checksum is the same value as the provided potential checksum, then flow proceeds to block 405. If the calculated checksum is not the same value as the provided potential checksum, then the checksum success decision block 421.1-421.N repeats the process on a new provided checksum and preceding bytes, where the new provided checksum and preceding bytes represent a shift in bits that is a function of success or failure of the Manchester decode step 210.3 and the payload decode step 210.4. For example, if the next bit in the stream provided by the ADC step 403 is successful, then the shift is 1 bit. If the next 2 bits provided by the ADC step 403 fail and the following bit is successful, then the shift is 3 bits.

Accordingly, processing resources are not wasted on detection and reception of sync sequences, which in virtually all ERT variants represent 10 to 20 percent of the packet bits. Because the bit streams are being oversampled, likelihood of packet reception is increased, and processing resources are freed up which would otherwise be dedicated to sync sequence detection. Consequently, the likelihood of packet reception is increased because the detection and reception of preamble/sync sequence, which in virtually all ERT variants represent 10-20 percent of the packet bits is not required for reception or validation.

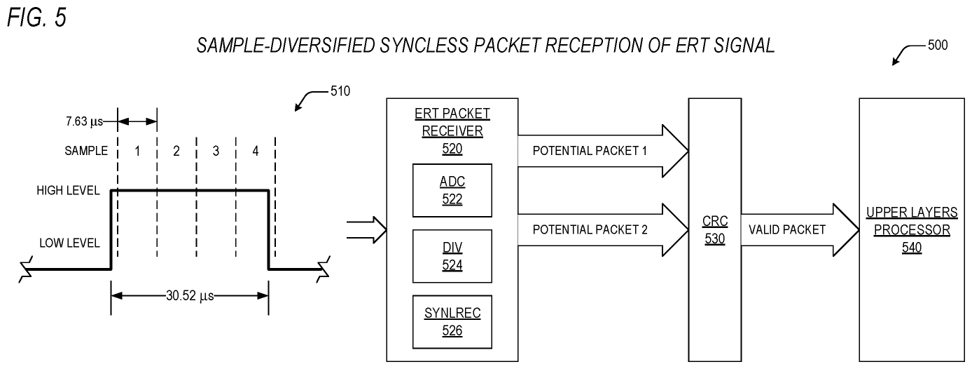

Referring now to FIG. 5, a block diagram 500 is presented illustrating a 4-sample diversified syncless packet reception mechanism according to the present invention, which is a specific embodiment of the sample-diversified syncless packet reception flow 400 of FIG. 4. In the embodiment of FIG. 5, the number of diversified sample phases that within a bit time is 4, which divides the 30.52 microsecond bit time up into 4 7.63 microsecond phases. A downconverted ERT RF bit stream is provided to an ERT packet receiver 520 according to the present invention. Like that discussed above with reference to FIGS. 2-4, the receiver 520 includes an ADC 522, a sample diversifier 524, and a syncless packet reception element 526, where the syncless packet reception element 526 includes 4 corresponding syncless bit phase reception elements like those elements 420.1-420.N discussed above with reference to FIG. 4. One embodiment of the syncless packet reception element 526 may only include 3 syncless bit phase reception elements because as shown in waveform diagram 510, part of the 4th sampling phase runs into the next bit time. This is due to a slight delay after edge detection to start sample 1. Therefore, the entire phase window of samples 1-4 is shifted in time.

As is also discussed above, only those packets that are successfully Manchester—and payload-decoded are provided as potential packets (along with their checksum bytes) to a CRC element 530. Note in the diagram that only two potential packets/checksums are provided to the CRC element 530: one from phase 1 sample time and one from phase 2 sample time. It is presumed that processing of phase 3 and 4 sample times either failed to produce a valid potential packet or they were never sampled due to system optimization considerations. In this diagram 500, the CRC element includes packet validation logic to validate the two potential packets and to issue a valid packet to an upper layers processor 540.

The upper layers processor 540 is configured to process a stream of valid packets from a plurality of single-channel ERT packet receivers 520, where the number of channels comports with the number of hopping channels in the particular ERT protocol for which the system is configured. As is noted earlier, the maximum number of ERT channels is 60, though the system 100 according to the present invention is capable of adaptation to any number of frequency channels that are commensurate with whatever protocol is being employed.

The present inventors have observed that in testing a 4-phase ERT receiver, such as the receiver 520 of FIG. 5, sample 3 is the optimum sample to process in order to maximize packet throughput and sample 2 stream is the second-best chance at improving packet reception. Sample 1 and 4 are too close to the edges to offer significant improvement. Regardless of the number of sample bins implemented, it follows that the sample bins nearest to the center of the bit time are more desirable for improvements in packet reception.

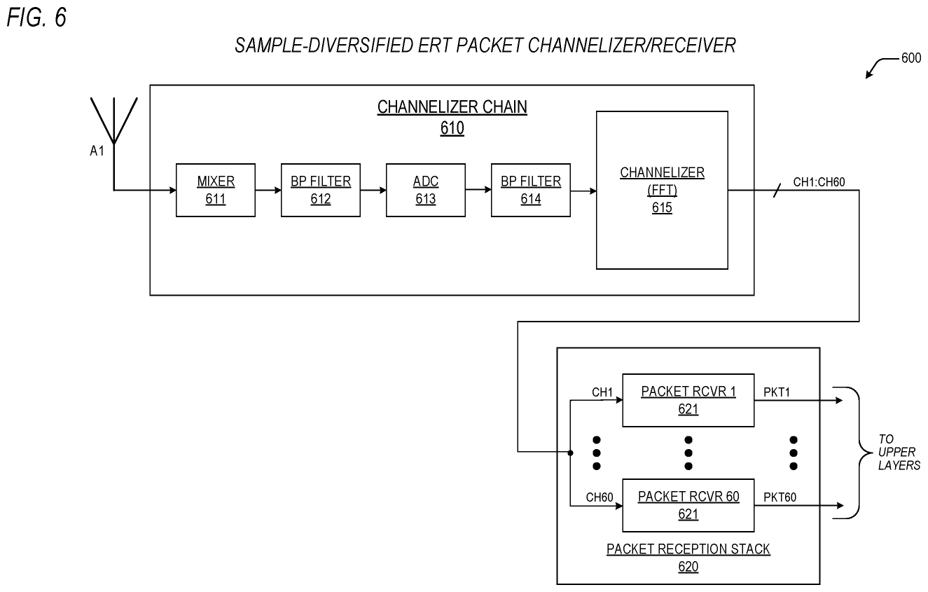

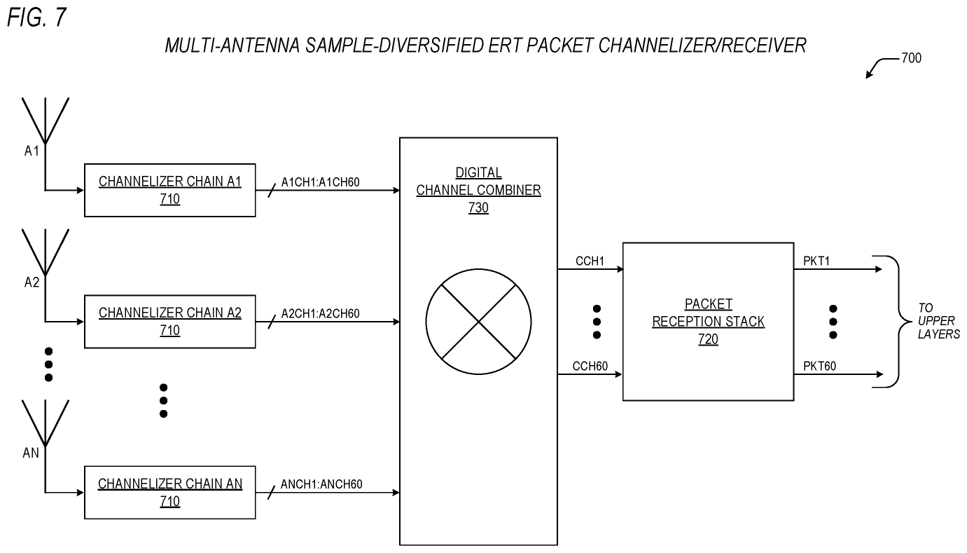

The discussion above with reference to FIGS. 2-5 has primarily focused on employing sample diversity to improve packet reception, yet the present invention also provides for parallel processing of frequency channels, and this aspect of a receiver according to the present invention will now be discussed with reference to FIGS. 6-7.

Referring now to FIG. 6, a block diagram is presented detailing a sample-diversified ERT packet channelizer/receiver 600 according to the present invention. The channelizer/receiver 600 includes a channelizer chain 610 that is coupled to an antenna A1 that is configured to receiver RF transmission in a specified frequency band. In an embodiment that is configured to collect meter data from AMR meters that transmit according to variant of the ERT protocol, the antenna A1 may comprise a 900 MHz omnidirectional antenna A1.

The channelizer chain 601 is coupled to a packet reception stack 620 via a specified number of frequency channel busses. In an ERT embodiment, the specified number of frequency channel busses is 60 busses corresponding to the 60 200 kHz ERT channels in the 900 MHz spectrum. The packet reception stack 620 may comprise a specified number of sample-diversified packet receivers 621 that each performs sample-diversified packet reception a corresponding one of the specified frequency channels. In an ERT embodiment, the number of sample-diversified packet receivers in the packet reception stack is 60, each corresponding to one of the 60 ERT channel. Received valid packets PKT1-PKT65 from the stack 620 are routed to upper layers of the collector 103 for formatting and transmission to energy services 104 via associated communication links COMM A, COMM B, COMM C.

The channelizer chain 610 includes a mixer 611 that is coupled to the antenna and that converts received RF signals to protocol baseband, as is discussed above. In an ERT embodiment, the mixer 611 outputs 60 200 kHz-wide channels corresponding to all of the ERT channel frequencies. The mixer output passes through a bandpass filter 612 to further reduce system noise.

The output of filter 612 is provided to an ADC 613. In an ERT embodiment that employs 4-sample sampling diversity, the ADC 613 converts the analog stream to a digital stream of that is 4 times the bit rate of ERT baseband (32,768 bits/second), thus providing a 131,072 samples/second stream as a sampling diversity receiver according to the present invention will process between 1 and 4 of the oversampled phases of each bit. The output of the ADC 613 also passes through a bandpass filter 614 to reduce noise.

The 131,072 samples/second stream from the bandpass filter 614 is provided to a channelizer element 615. In one embodiment the channelizer element comprises an FFT 615 that runs at 200 kHz. The 60 frequency channels CH1: CH60 that are of interest for processing of the ERT frequency bands.

The 60 channels of interest CH1: CH60 are each coupled to a corresponding sample-diverse packet receiver 621 within the packet reception stack 620 and each of the receivers 621 operates to detect, demodulate, and decode packets within a corresponding frequency band. For example, all of the packet receivers 621 are simultaneously processing sample streams provided by the channelizer chain 610, where each stream corresponds to one of all of the frequency bands within the specified protocol. In an ERT embodiment, packet receiver 1 621 processes a sample stream CH1 corresponding to the lowest-frequency ERT channel and packet receiver 60 621 processes a sample stream CH60 corresponding to the highest-frequency ERT channel.

In summary, the channelizer chain 610 receives the full frequency spectrum according to the specified protocol, digitizes received RF signals within that spectrum, and channelizes those digitized signals into individual frequency channels CH1: CH60. The individual channels CH1: CH60 are routed to packet receivers 621, which detect energy edges at their inputs and then determine bit timing, set DC balance, look for sync words, decode raw bits to packet bits, convert bits into bytes, and perform a CRC check to determine valid packets. It is noted that the packet receivers 621 of the channelizer/receiver 600 of FIG. 6 may be configured to detect sync words (“syncfull receiver”) as is discussed with reference to FIG. 3 or they may be configured for syncless packet reception as is discussed above with reference to FIGS. 4-5.

The embodiment of FIG. 6 employs a single antenna A1; however, the present inventors have observed than use of more than one antenna for protocols such as ERT can significantly improve packet throughput, where channelized signals are combined at baseband. As one skilled in the art will appreciate, analog beamforming is accomplished by taking multiple antennas and combining the signals with phase delay, where the delay accomplishes the constructive interference and increases signal strength. All of the phase shifting, and signal combining is performed at the RF transmission frequency.

Rather than employing analog beamforming, the present invention contemplates digital beamforming of received signals, where combining of the signals is performed at baseband and where no phase shifting is applied. That is, digital combining combines multiple antenna signals after downconversion at baseband without introducing any phase delay. For OOK systems, digital combining realizes the same signal strength benefit as analog beamforming but uses a much simpler and lower cost system to achieve it. When using just two omnidirectional antennas, the present inventors have observed a 100 percent improvement in packet throughput through employment of this technique.

Turning now to FIG. 7, a block diagram is presented showing a multiple-antenna embodiment of a sample-diversified ERT packet channelizer/receiver 700 according to the present invention that employs digital combining of baseband signals.

The channelizer/receiver 700 has N antennas A1-AN that are each coupled to corresponding channelizer chains 710 that operate in substantially the same manner as the channelizer chain 610 described above with reference to FIG. 6. Each channelizer chain 710 output a corresponding 60 frequency channels to a digital channel combiner 730 that sums each channel A1CH1: A1CH60 from channelizer chain A1 710 with corresponding channels output by channelizer chain A2-AN. That is, the digital channel combiner 730 sums the energy value of channel A1CH1 with the energy values of channel A2CH1 through channel ANCH1 to generate combined channel output CCH1. Likewise, the digital channel combiner 730 sums the energy value of channel A1CH2 with the energy values of channel A2CH2 through channel ANCH2 to generate combined channel output CCH2. And so on through summing A1CH60-ANCH60 to form CCH60.

Each of the combined channels CCH1-CCH60 is provided to corresponding packet receivers (not shown) within packet reception stack 720, which operate like packet reception stack 620 of FIG. 6 to generate received packets PKT1-PKT60, which are provided to upper layer processors (not shown) of the collector 103 according to the present invention.

Advantageously, the digital channel combiner 730 according to the present invention realizes a significant increase in packet reception without requiring analog phase shifters or analog combiners at RF transmission frequencies, resulting in a much simpler, lower cost system 100. The time delay of each of the antennas A1-AN appears in the combined signals CCH1-CCH60 as “humps” on the leading and trailing edges of logical 1 bits. In many practical, situations, especially for OOK modulation, these humps cause no detrimental effect to demodulation, particularly if the time delays are much shorter than the baseband bit rate. For example, if two antennas are spaced 1 meter apart, the physical time delay of the RF transmission at the speed of light is roughly 3.3 nanoseconds. A system receiving ERT transmissions at 32,768 bits per second would not even note such a short delay because ERT bit times are approximately 30.5 microseconds. Similarly, a multipath bounce would have to be 9,150 meters to delay by a single ERT bit time, and the resulting signal level of such a bounce would be greatly reduced relative to the direct RF path, which would not affect the combined signal significantly.

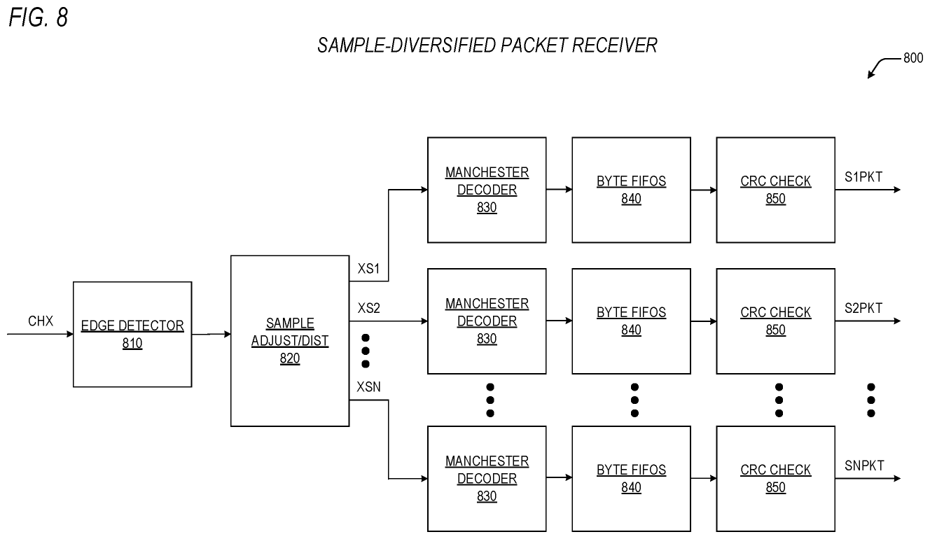

Referring now to FIG. 8, a block diagram is presented illustrating a sample-diversified packet receiver 800 according to the present invention. Operation of this receiver is discussed above with reference to the flow diagrams 300-400 of FIGS. 4-5, which provide essential steps performed by the elements of the receiver 800.

The receiver 800 may comprise an edge detector 810 that receives a digital frequency channel signal CHX from a channelizer chain like the channelizer chain 610 of FIG. 6 or, in a multi-antenna embodiment, from a digital channel combiner like the combiner 730 of FIG. 7. The receiver 800 represents one of the sample-diversified packet receivers within a packet reception stack, such as is illustrated in FIG. 6.

The edge detector 810 may comprise a byte FIFO and is coupled to a sample adjustment/distribution element 820. The sample adjustment/distribution element 820 is coupled to a plurality of Manchester decoders 830 that each receive sample adjusted frequency channel signals XS1-XSN that each include values corresponding to a particular bit phase of a potential bit following edge detection.

The Manchester decoders 830 are coupled to corresponding byte FIFOs and the byte FIFOs 840 are coupled to corresponding CRC checksum elements 850.

In operation, when an edge within CHX is detected by the edge detector 810, the sample stream is provided to the sample adjuster/distribution element 820. Element 820 is configured to convert the sample rate output by the channelizer to the sample rate of the bit stream that is to be detected. For example, in an ERT configuration, channelizer 615 outputs samples for each FFT bin at 200 kHz, yielding samples at approximately 6.1 times that of and ERT bitstream that is oversampled by a factor of 4. For a 4-sample diversified ERT embodiment, it is desired to have a sample stream of 1,311,072 samples per second. Element 820 converts the channelizer sample rate to the required sample stream sample rate and then distributes those samples to their respective Manchester decoder 830. Element 820 may also be configured to detect known sync words according to protocol and to initiate provision of bits to the decoders 830 upon successful reception of sync sequences.

Each Manchester decoder 830 may comprise a byte FIFO and operationally converts raw (encoded) bytes to packet bytes. The packet bytes are provided to corresponding byte FIFOs, which queue up as received potential packets. The received potential packets along with their received checksum values are provided to respective CRC check elements 850. The CRC check elements 850 calculate a CRC checksum of the potential packet bytes and compare the checksum to the received checksum. Verified packets from one or more of the samples XS1-XSN are provided to packet validation logic (not shown) via busses S1PKT-SNPKT. The sample diversified receiver 800 may be configured as a syncfull or syncless receiver 800 according to desired embodiment.

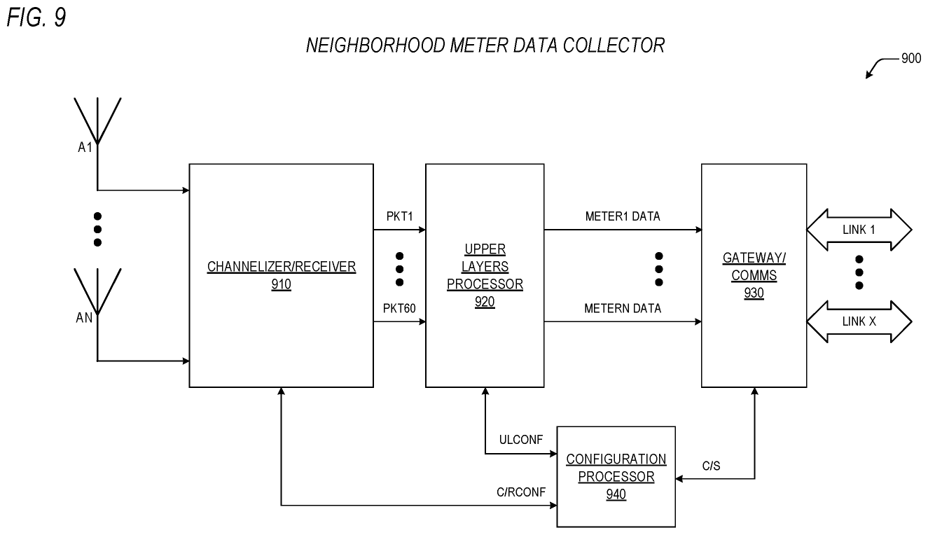

Finally turning to FIG. 9, a block diagram is presented depicting a programmable neighborhood-level meter data collector 900 according to the present invention. The present inventors have noted that there is a very diverse mix of AMR meter configurations, where one type of AMR meter is deployed in a neighborhood and a different type of AMR meter is deployed in the next neighborhood. A given neighborhood may have several different types of AMR meters deployed therein where the different types of meters employ different ERT protocols for broadcast of energy consumption data. Furthermore, a given neighborhood may have more than one utility (e.g., electricity, water, gas) whose meters operate in differing protocols. It is noted that though the collection system 100 according to the present invention is capable of detecting, demodulating, and decoding energy meter data transmissions for all well-known protocols, it is desirable to maximize packet reception rates for those meters/protocols which are deployed in a given neighborhood. Accordingly, the present invention is directed toward provision of a programmable neighborhood meter data collector that is configured according to neighborhood requirements upon power up or other reprogramming mechanisms. That is, rather than fixing a receiver configuration in receiver hardware, the present invention provides for dynamic configuration of the collector 900.

The collector 900 may comprise one or more antennas A1-AN that are coupled to a channelizer/receiver stack 910. If the collector 900 includes more than one antenna A1-AN, then the stack 910 may comprise a digital combiner as is described above with reference to FIG. 7. The stack 910 may comprise a plurality of sample-diversified receivers to comport with frequency channel count and also sample diversity requirements. For example, the receivers for each channel may be configurable to utilize two samples, three samples, four samples, and so on up to a limit that is consistent packet reception timing requirements. Packets decoded by the channelizer/receiver stack 910 are provide via busses PKT65-PKT124 to an upper layers processor 920. The upper layers processor 920 provides formatted meter data for transmission to one or more energy services 104 via busses METER1 DATA-METERN DATA, where N is the number of meters that are within coverage range of the collector 900. The meter data is provided to a gateway/communications element 930 that couples the collector 900 to one or more communication links LINK1-LINKX, as is described above with reference to FIG. 1, where one or more of the links LINK1-LINKX are employed to transmit meter data to one or more of the energy services 104.

One or more of the links LINK1-LINKX may be employed to couple the collector 900 to a network operations center (not shown) where the network operations center is configured to monitor operational status of the collector 900 and to transmit messages to the collector 900 that include configuration data for the collector 900

A configuration/status bus C/S couples a configuration processor 940 to the gateway/communications element 930. The configuration processor 940 is coupled to the channelizer/receiver stack 910 via but C/RCONF and o the upper layers processor 920 via bus ULCONF.

In operation, the collector 900 sends decoded meter data to the energy services 104 through the gateway 930. The configuration processor 940 monitors operational state of the channelizer/receiver stack 910 via bus C/RCONF and of the upper layers processor 920 via bus ULCONF. The configuration processor 940 may periodically report status of the collector 900 via bus C/S.

The collector 900 may receive specific configuration messages from the network operations center through the gateway 930 and these configuration messages are provided to the configuration processor 940. The configuration processor 940 is configured to pause operation of the collector 900 via busses ULCONF and C/RCONF and may provide messaging over these busses to the channelizer/receiver stack 910 and the upper layers processor 920 to optimize operation of the collector for its deployed geographical area. Examples of such messaging includes, but is not limited to:
enabling or disabling one or more diversified sample receivers to meet throughput requirements, such as disabling selected diversified sample receivers that are not required for optimum reception of packets;
enabling or disabling selected frequency channels to comport with frequency channels utilized by transmitters within the area of deployment; and
configuring the upper layers processor 920 to ignore certain packet sequences that are associated with AMR meters that are not to be monitored (e.g., gas meters).

The neighborhood meter data collector 900 according to the present invention is configured to perform the functions and operations as discussed above. The collector 900 may comprise logic, circuits, devices, or microcode (i.e., micro instructions or native instructions), or a combination of logic, circuits, devices, or microcode, or equivalent elements that are employed to execute the functions and operations according to the present invention as noted. The elements employed to accomplish these operations and functions within the collector 900 may be shared with other circuits, microcode, etc., that are employed to perform other functions and/or operations within the collector 900. According to the scope of the present application, microcode is a term employed to refer to a plurality of micro instructions. A micro instruction (also referred to as a native instruction) is an instruction at the level that a unit executes.

The configuration processor 940, channelizer/receiver stack 910, and upper layers processor 920 may be embodied as one or more central processing units (CPUs) (not shown) that are coupled to memory (not shown). The memory may comprise a combination of both non-transitory and transitory memory. The memory may comprise an operating system (OS), such as MacOS, Unix, Linux, Windows, and the like, and one or more application programs that implement the functions as described above.

In various embodiments, the one or more application programs are configured to perform the functions discussed above are stored in the non-transitory storage memory, transferred to the transitory storage memory at run time, and executed by the one or more CPUs.

Portions of the present invention and corresponding detailed description are presented in terms of software, or algorithms and symbolic representations of operations on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” or “displaying” or the like, refer to the action and processes of a computer program product, a computer system, a microprocessor, a central processing unit, or similar electronic computing device, that manipulates and transforms data represented as physical, electronic quantities within the computer system's registers and memories into other data similarly represented as physical quantities within the computer system memories or registers or other such information storage, transmission or display devices. The devices may comprise one or more CPUs that are coupled to a computer-readable storage medium. Computer program instructions for these devices may be embodied in the computer-readable storage medium. When the instructions are executed by the one or more CPUs, they cause the devices to perform the above-noted functions, in addition to other functions.

Note also that the software implemented aspects of the invention are typically encoded on some form of program storage medium or implemented over some type of transmission medium. The program storage medium may be electronic (e.g., read only memory, flash read only memory, electrically programmable read only memory), random access memory magnetic (e.g., a floppy disk or a hard drive) or optical (e.g., a compact disk read only memory, or “CD ROM”), and may be read only or random access. Similarly, the transmission medium may be metal traces, twisted wire pairs, coaxial cable, optical fiber, or some other suitable transmission medium known to the art. The invention is not limited by these aspects of any given implementation.

The particular disclosed above are illustrative only, and those skilled in the art will appreciate that they can readily use the disclosed conception and specific embodiments as a basis for designing or modifying other structures for carrying out the same purposes of the present invention, and that various changes, substitutions and alterations can be made herein without departing from the scope of the invention as set forth by the appended claims. For example, components/elements of the systems and/or apparatuses may be integrated or separated. In addition, the operation of the systems and apparatuses disclosed herein may be performed by more, fewer, or other components and the methods described may include more, fewer, or other steps. Additionally, unless otherwise specified steps may be performed in any suitable order.

Although specific advantages have been enumerated above, various embodiments may include some, none, or all of the enumerated advantages.

1. A system for reception of radio transmissions, the system comprising:
a collector, coupled to a plurality of transmitters via a plurality of wireless radio frequency (RF) links, wherein:
each of the plurality of transmitters broadcasts corresponding encoded packets over a corresponding wireless RF link;
the broadcasts comport with one or more packet transmission protocols that are known by the collector; and
the collector is configured to detect, demodulate, and decode the broadcasts from the each of the plurality of transmitters to extract corresponding packet payloads;
the collector comprising:
a channelizer chain, configured to:
receive an RF signal stream comprising one or more broadcasts via an antenna tuned to a spectrum corresponding to the one or more packet transmission protocols;
downconvert the RF signal stream to an analog signal stream at a baseband of the one or more packet transmission protocols;
convert the analog signal stream into a digital bitstream; and
transform the digital bitstream into a plurality of channelized bit streams that comport with a number of frequency channels within the one or more packet transmission protocols; and
packet receivers, coupled to the channelizer chain in parallel relative to each other, each configured to:
receive a corresponding one of the plurality of channelized bit streams;
upon detection of a bit edge transition within the corresponding one of the plurality of channelized bit streams, process in parallel, a plurality of samples within each bit of the corresponding one of the plurality of channelized bit streams to detect a synchronization sequence, demodulate raw bits and transform the raw bits into packet bytes and checksum bytes, transform the packet bytes into a packet payload, compute a checksum of the packet bytes for comparison to the checksum bytes, and if the computed checksum is equal to the checksum bytes, provide the packet payload for validation;
validate corresponding packet payloads derived in parallel from more than one of the plurality of samples by selecting an optimum one of the corresponding packet payloads; and
provide the optimum one of the corresponding packet payloads to an upper layers processor for formatting and transmission to one or more entities.

2. The system as recited in claim 1, wherein:
the plurality of transmitters comprises advanced meter reading (AMR) meters; and
the one or more packet protocols comprise Encoded Receiver Transmitter (ERT) protocols.

3. The system as recited in claim 1, wherein the plurality of transmitters comprises more than 200 transmitters.

4. The system as recited in claim 1, wherein the spectrum comprises 60 channels within a 900 MHz spectrum and each of the 60 channels is 200 kHz wide.

5. The system as recited in claim 1, wherein the plurality of samples comprises 4 samples per bit time.

6. The system as recited in claim 1, wherein the plurality of samples comprises 6 samples per bit time.

7. The system as recited in claim 1, wherein the optimum one of the corresponding packet payloads is selected via a statistical ranking that shows the optimum one of the corresponding packet payloads is determined to have the highest probability of being a valid packet payload.

8. A system for reception of radio transmissions, the system comprising:
a collector, coupled to a plurality of Advanced Meter Reading (AMR) meters via a plurality of wireless radio frequency (RF) links, wherein:
each of the plurality of AMR meters broadcasts corresponding encoded packets over a corresponding wireless RF link;
the broadcasts comport with one or more Encoder Receiver Transmitter (ERT) packet transmission protocols that are known by the collector; and
the collector is configured to detect, demodulate, and decode the broadcasts from the each of the plurality of AMR meters to extract corresponding ERT packet payloads;
the collector comprising:
a channelizer chain, configured to:
receive an RF signal stream comprising one or more broadcasts via an antenna tuned to a spectrum corresponding to the one or more ERT packet transmission protocols;
downconvert the RF signal stream to an analog signal stream at a baseband of the one or more ERT packet transmission protocols;
convert the analog signal stream into a digital bitstream; and
transform the digital bitstream into a plurality of channelized bit streams that comport with a number of frequency channels within the one or more ERT packet transmission protocols; and
packet receivers, coupled to the channelizer chain in parallel relative to each other, each configured to:
receive a corresponding one of the plurality of channelized bit streams;
upon detection of a bit edge transition within the corresponding one of the plurality of channelized bit streams, process in parallel, a plurality of samples within each bit of the corresponding one of the plurality of channelized bit streams to detect a synchronization sequence, demodulate raw bits and transform the raw bits into packet bytes and checksum bytes, transform the packet bytes into an ERT packet payload, compute a checksum of the packet bytes for comparison to the checksum bytes, and if the computed checksum is equal to the checksum bytes, provide the ERT packet payload for validation;
validate corresponding ERT packet payloads derived in parallel from more than one of the plurality of samples by selecting an optimum one of the corresponding ERT packet payloads; and
provide the optimum one of the corresponding ERT packet payloads to an upper layers processor for formatting and transmission to one or more energy services.

9. The system as recited in claim 8, wherein the one or more energy services comprise an electricity supplier, a natural gas supplier, and a water supplier.

10. The system as recited in claim 8, wherein the plurality of transmitters comprises more than 200 transmitters.

11. The system as recited in claim 8, wherein the spectrum comprises 60 channels within a 900 MHz spectrum and each of the 60 channels is 200 kHz wide.

12. The system as recited in claim 8, wherein the plurality of samples comprises 4 samples per bit time.

13. The system as recited in claim 8, wherein the plurality of samples comprises 6 samples per bit time.

14. The system as recited in claim 8, wherein the optimum one of the corresponding ERT packet payloads is selected via a statistical ranking that shows the optimum one of the corresponding ERT packet payloads is determined to have the highest probability of being a valid ERT packet payload.

15. A method for reception of radio transmissions, the method comprising:
coupling a collector to a plurality of transmitters via a plurality of wireless radio frequency (RF) links, wherein:
each of the plurality of transmitters broadcasts corresponding encoded packets over a corresponding wireless RF link;
the broadcasts comport with one or more packet transmission protocols that are known by the collector; and
the collector is configured to detect, demodulate, and decode the broadcasts from the each of the plurality of transmitters to extract corresponding packet payloads;
via a channelizer chain disposed within the collector:
receiving an RF signal stream comprising one or more broadcasts via an antenna tuned to a spectrum corresponding to the one or more packet transmission protocols;
downconverting the RF signal stream to an analog signal stream at a baseband of the one or more packet transmission protocols;
converting the analog signal stream into a digital bitstream; and
transforming the digital bitstream into a plurality of channelized bit streams that comport with a number of frequency channels within the one or more packet transmission protocols; and
via each of a plurality of packet receivers disposed within the collector and coupled to the channelizer chain in parallel relative to each other:
receiving a corresponding one of the plurality of channelized bit streams;
upon detection of a bit edge transition within the corresponding one of the plurality of channelized bit streams, processing in parallel, a plurality of samples within each bit of the corresponding one of the plurality of channelized bit streams to detect a synchronization sequence, demodulate raw bits and transform the raw bits into packet bytes and checksum bytes, transform the packet bytes into a packet payload, compute a checksum of the packet bytes for comparison to the checksum bytes, and if the computed checksum is equal to the checksum bytes, provide the packet payload for validation;
validating corresponding packet payloads derived in parallel from more than one of the plurality of samples by selecting an optimum one of the corresponding packet payloads; and
providing the optimum one of the corresponding packet payloads to an upper layers processor for formatting and transmission to one or more entities.

16. The method as recited in claim 15, wherein:
the plurality of transmitters comprises advanced meter reading (AMR) meters; and
the one or more packet protocols comprise Encoded Receiver Transmitter (ERT) protocols.

17. The system as recited in claim 15, wherein the spectrum comprises 60 channels within a 900 MHz spectrum and each of the 60 channels is 200 kHz wide.

18. The system as recited in claim 15, wherein the plurality of samples comprises 4 samples per bit time.

19. The system as recited in claim 15, wherein the plurality of samples comprises 6 samples per bit time.

20. The system as recited in claim 15 wherein the optimum one of the corresponding packet payloads is selected via a statistical ranking that shows the optimum one of the corresponding packet payloads is determined to have the highest probability of being a valid packet payload.
